(19) United States
(12) Patent Application Publication
(10) Pub. No.: US 2025/0024525 A1
(43) Pub. Date: Jan. 16, 2025

(54) UPLINK RE-TRANSMISSION VIA SIDELINK

(71) Applicant: Nokia Technologies Oy, Espoo (FI)

(72) Inventors: Berthold PANZNER, Munich (DE); Rakash SIVASIVA GANESAN, Munich (DE); Wolfgang ZIRWAS, Munich (DE)

(21) Appl. No.: 18/711,501

(22) PCT Filed: Dec. 10, 2021
(86) PCT No.: PCT/EP2021/085250

§ 371 Date: May 17, 2024

(51) Int. Cl. H04W 76/10; H04L 1/08; H04L 5/00; H04W 72/1268; H04W 74/0816; H04W 92/18

(52) U.S. Cl. CPC H04W 76/10; H04L 1/08; H04L 5/0053; H04W 72/1268; H04W 74/0816; H04W 92/18

(57) ABSTRACT

The disclosure inter alia relates to a first user equipment, first UE, comprising means for: —performing an uplink transmission to a base station in a serving cell, the uplink transmission being associated with the transmission of an uplink transport block; —establishing a sidelink connection with a second user equipment, second UE; —transmitting, to the second UE, a re-transmission request for an uplink re-transmission to the base station in the serving cell by the second UE on behalf of the first UE, the uplink re-transmission being associated with the transmission of the uplink transport block; —transmitting, to the second UE, context information to be used by the second UE for the uplink re-transmission; and-transmitting, to the second UE, uplink data to be used by the second UE for the uplink re-transmission.

### BACKGROUND

The present disclosure is related but not limited to communication networks as defined by the 3GPP standard, such as the 5G standard, also referred to as New Radio, NR.

5G systems will extend mobile communication services beyond mobile telephony, mobile broadband, and massive machine-type communication into new application domains, such as so-called “vertical domains”, the industrial internet of things (“IIoT”) or vehicle to everything communication (“V2X”), with special requirements toward communication services. For these scenarios, there are demanding requirements, such as a high availability, high reliability, low latency for the mobile communications. Such communication is also referred to as Ultra-Reliable Low-Latency Communication (“URLLC”).Communication for automation in vertical domains has to support the applications in the corresponding scenario, for instance, industrial automation, energy automation or transportation.

For the respective use cases and in particular the scenario of the industrial internet of things, there is the requirement of a very high reliability of e.g. 99.999% or even 99.9999% or even higher (see for instance Section 8.1 of 3GPP TS 22.804, v16.3.0). In order to achieve such a high reliability, redundancy has been introduced in different layers e.g. through channel coding, robust modulation and coding scheme, hybrid ARQ re-transmission, PDCP duplication, higher layer multi-connectivity, redundancy protocols external to 3GPP network like frame replication and elimination for reliability (IEEE 802.1CB) or even application level redundancy. The increased reliability is obtained as a trade off with latency and/or spectral resources.

For industrial communication the mean time between failures is expected to be in the range of 1 day to 10 years (see for instance Table 5.2.1 in 3GPP TS 22.104, v18.2.0). At the same time, the survival time for such application is typically in the range from few milliseconds to 50 ms. The survival time is defined by 3GPP as the time duration during which an (industrial) application can continue to work even when there is no new information received. Thus, the survival time defines the maximum end-to-end (“E2E”) delay acceptable in the considered use case. That means, that any interruption of the communication longer than this duration shall result in communication failure, which, according to the above expectation, is only expected as rarely as every 10 years. One reason for such an interruption time may be the handover (“HO”) interruption or handover failure which can be up to several seconds.

One possibility to approach this issue is to deploy redundant hardware to avoid a single point of failure. Especially deploying redundant user equipments, UEs, can overcome several failures including blockage, handover interruption or failure etc. Here, the redundant UEs can be connected to same or different base stations.

For instance, the technical report 3GPP TRS 22.832, v17.4.0 “Study on enhancements for cyber-physical control applications in vertical domains” proposes to deploy multiple UEs to overcome link disruption by suggesting to coordinate operations that increase the likelihood of a link disruption at scheduled TSN Tx/Rx times between redundant UEs so they do not occur simultaneously. This shall include operations that involve an RRC Reconfiguration (e.g., handover when there may be a brief link interruption).

Correspondingly, multiple UEs have been considered for E2E reliability enhancements in the following, see 3GPP TS 23.501 “System architecture for the 5G System (5GS)”, v17.2.0, Annex F. This solution is stated as an implementation option of the Single UE solution proposed in Section 5.33.

Furthermore, for integration of 5GS in industrial time sensitive network (“TSN”), 5GS supports several TSN protocols including time synchronization protocol (gPTP), network discovery (LLDP) and protocols to enable deterministic behavior (802.1Qbv). In addition to such protocols for deterministic behavior of TSN, there is a E2E reliability enhancement protocol, Frame Replication and Elimination for Reliability (“FRER”). Here, the 5GS needs to perform one or more of the operations: duplicate packets, eliminate duplicates and carry redundant packets which are duplicated by 5GS itself or by external TSN network. On one hand, 5GS has its internal reliability mechanism developed for URLLC (see 3GPP TR 23.725, v16.2.0, “Study on enhancement of Ultra-Reliable Low-Latency Communication (URLLC) support in the 5G Core network”). On the other hand there is E2E (5GS+TSN network) reliability enhancement defined by FRER. These enhancements may be combined efficiently e.g. by transmitting the redundant copies of FRER only over the air interface and transmit a single copy over the core network. In order to enable such optimization, the replication framework introduced in Section 6.7 in 3GPP TR 23.725 may be used, stating that, based on the application functionality to support redundancy by default, the replicator framework can eliminate further replications and transmit the packet stream just once towards the lower layers.

For further illustration, it is referred to FIG. 1a), showing an example scenario where a UE in an industrial environment (such as a manufacturing hall) is connected to a sensor and transmit this sensor's data to an eNB/gNB in a URLLC scenario. Due to the very nature of wireless transmission over a fading channel, the single wireless link is a single source of failure and prone to packet errors. For example the single wireless link between the UE and the eNB/gNB might be temporarily blocked by automated guided vehicles (AGV) or electromagnetic interference (EMI) due to nearby welding machines. In the scenario above the wireless link is a problem due to:
the single point of failure by just uploading the sensor data over a single wireless link;
packet errors that occur due to this wireless connection.

A way to approach the above problem would be to add redundancy to meet the reliability requirements by simply duplicating the wireless link (i.e. adding more UEs that transmit in parallel the very same sensor data over additional wireless links), as illustrated in FIGS. 1b) and 1c). However, added redundancy (and hence increased reliability) comes with a trade off in increased energy consumption, increased latency and increased spectral resources. The replicator functionality configured at the gNB by the session management function (SMF) eliminates the duplicates and forwards a single copy of the data towards the core network user plane function (see Section 6.7.2.2. of 3GPP TR 23.725 for how such configuration may take place). In other words, after successfully decoding the first copy of the packet, the gNB discards the redundant packet. That is, when a packet is successfully decoded, the additional resources (e.g. radio resources, energy) spent for transmitting the redundant packet over the redundant radio leg (second Uu connection) is wasted.

In view of the above, there remains the problem of improving the approaches of the prior art presented above.

### SUMMARY OF SOME EXEMPLARY EMBODIMENTS

Certain embodiments of the invention may have the effect of minimizing the resources needed to perform a reliable transmission without unnecessarily wasting redundant resources that are not needed in the case of successful reception.

According to a first exemplary aspect, a first user equipment, first UE, is disclosed, comprising means for:
performing an uplink transmission to a base station in a serving cell, the uplink transmission being associated with the transmission of an uplink transport block;
establishing a sidelink connection with a second user equipment, second UE;
transmitting, to the second UE, a re-transmission request for an uplink re-transmission to the base station in the serving cell by the second UE on behalf of the first UE, the uplink re-transmission being associated with the transmission of the uplink transport block;
transmitting, to the second UE, context information to be used by the second UE for the uplink re-transmission; and
transmitting, to the second UE, uplink data to be used by the second UE for the uplink re-transmission.

According to a second exemplary aspect, a second user equipment, second UE, is disclosed, comprising means for:
establishing a sidelink connection with a first user equipment, first UE;
receiving, from the first UE, a re-transmission request for an uplink re-transmission to a base station in a serving cell by the second UE on behalf of the first UE, the uplink re-transmission being associated with the transmission of an uplink transport block;
receiving, from the first UE, context information to be used by the second UE for the uplink re-transmission;
receiving, from the first UE, uplink data to be used by the second UE for the uplink re-transmission; and
performing the uplink re-transmission to the base station in the serving cell on behalf of the first UE.

According to a third exemplary aspect, a base station is disclosed, comprising means for:
receiving, from a first user equipment, first UE, an indication for uplink re-transmission via another user equipment;
transmitting, to the first UE, a first uplink grant providing a first uplink transmission opportunity for an uplink transmission to the base station in a serving cell, the uplink transmission being associated with the transmission of an uplink transport block; and
transmitting, to the first UE, a second uplink grant providing a second uplink transmission opportunity for an uplink re-transmission to the base station in the serving cell, the uplink re-transmission being associated with the transmission of the uplink transport block;
adjusting a time separation between the transmission of the second uplink grant and the second uplink transmission opportunity based on the indication; and
receiving, from a second user equipment, second UE, the uplink re-transmission on behalf of the first UE.

According to each exemplary aspect, a respective method is also disclosed.

Thus, according to the first exemplary aspect, a method, performed by a first user equipment, first UE, is disclosed, the method comprising:
performing an uplink transmission to a base station in a serving cell, the uplink transmission being associated with the transmission of an uplink transport block;
establishing a sidelink connection with a second user equipment, second UE;
transmitting, to the second UE, a re-transmission request for an uplink re-transmission to the base station in the serving cell by the second UE on behalf of the first UE, the uplink re-transmission being associated with the transmission of the uplink transport block;
transmitting, to the second UE, context information to be used by the second UE for the uplink re-transmission; and
transmitting, to the second UE, uplink data to be used by the second UE for the uplink re-transmission.

According to the second exemplary aspect, a method, performed by a second user equipment, second UE, is disclosed, the method comprising:
establishing a sidelink connection with a first user equipment, first UE;
receiving, from the first UE, a re-transmission request for an uplink re-transmission to a base station in a serving cell by the second UE on behalf of the first UE, the uplink re-transmission being associated with the transmission of an uplink transport block;
receiving, from the first UE, context information to be used by the second UE for the uplink re-transmission;
receiving, from the first UE, uplink data to be used by the second UE for the uplink re-transmission; and
performing the uplink re-transmission to the base station in the serving cell on behalf of the first UE.

According to the third exemplary aspect, a method, performed by a base station, is disclosed the method comprising:
receiving, from a first user equipment, first UE, an indication for uplink re-transmission via another user equipment;
transmitting, to the first UE, a first uplink grant providing a first uplink transmission opportunity for an uplink transmission to the base station in a serving cell, the uplink transmission being associated with the transmission of an uplink transport block; and
transmitting, to the first UE, a second uplink grant providing a second uplink transmission opportunity for an uplink re-transmission to the base station in the serving cell, the uplink re-transmission being associated with the transmission of the uplink transport block;
adjusting a time separation between the transmission of the second uplink grant and the second uplink transmission opportunity based on the indication; and
receiving, from a second user equipment, second UE, the uplink re-transmission on behalf of the first UE.

Any of the disclosed user equipments may be stationary device or a mobile device. The user equipment may in particular be a mobile device, such as a smartphone, a tablet, a wearable, a smartwatch, a low power device, an IoT device, an IIoT device or the like. The user equipment may in particular be capable of obtaining sensor data (e.g. from an external device) and transmit the received sensor data to the base station of a communication network. Generally, the user equipment may also be any other device enabled for communication with a respective communication network, such as a vehicle, for instance a car or a truck. A user equipment or mobile station may be understood as any device used to communicate with a respective network. The user equipment of the first exemplary aspect may be capable of being in direct or indirect communication with a base station of the communication network and/or another user equipment, as will be explained in more detailed below.

A base station may be understood as a wireless communication station installed at a fixed or mobile location and may in particular be or comprise an entity of the radio access network of the communication system. For instance, the base station may be or comprise a base station of a communication network of any generation (e.g. a gNB, eNodeB, NodeB, BTS or the like) of the 3GPP standard. Generally, the base station may be or comprise a hardware or software component implementing a certain functionality. In an example, the base station may be an entity as defined by the 3GPP 5G or NR standard (also referred to as gNB). Accordingly, while the base station may be understood to be implemented in or be a single device or module, the base station may also be implemented across or comprise multiple devices or modules. As such, the base station may in particular be implemented in or be a stationary device. Multiple base stations of the exemplary aspect may in particular establish a communication system or network, which may in particular be a New Radio (NR) or 5G system (5GS) or any other mobile communications system defined by a past or future standard, in particular successors of the present 3GPP standards. The network entity of the second exemplary aspect may be capable of being in direct and/or indirect communication with the exemplary user equipment, as will be explained in more detail below.

In general, the means of any of the disclosed apparatuses (i.e. any of the user equipments and base station) can be implemented in hardware and/or software. They may comprise one or multiple modules or units providing the respective functionality. They may for instance comprise at least one processor for executing computer program code for performing the required functions, at least one memory storing the program code, or both. Alternatively. they could comprise for instance circuitry that is designed to implement the required functions, for instance implemented in a chipset or a chip, like an integrated circuit. In general, the means may comprise for instance one or more processing means or processors.

Thus, according to the respective exemplary aspects of the present disclosure, there is in each case also disclosed a respective apparatus (i.e. a base station and a respective user equipment) comprising at least one processor and at least one memory including computer program code, the at least one memory and the computer program code configured to, with the at least one processor, cause an apparatus at least to perform a method according to the respective aspect of the present disclosure.

Any of the above-disclosed exemplary aspects may, however, in general be performed by an apparatus, which may be a module or a component for a device, for example a chip. The disclosed apparatus may comprise the disclosed components, for instance means, processor, memory, or may further comprise one or more additional components.

According to the exemplary aspects of the present disclosure, there is in each case also disclosed a computer program, the computer program when executed by a processor of an apparatus causing said apparatus to perform a method according to the respective aspect.

The computer program may in each case be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory, for instance a Read-Only Memory (ROM) or hard disk of a computer, or be intended for distribution of the program, like an optical disc.

In the following, further exemplary features and exemplary embodiments of the different aspects of the present disclosure will be described in more detail.

As described, the first UE may perform an uplink transmission to a base station in a serving cell, the uplink transmission being associated with the transmission of an uplink transport block (or uplink pay load). For instance, the uplink transmission may be performed via a physical uplink shared channel (PUSH). Generally, for this, the first UE will have established a connection with the base station and may have established a physical and logical connection with the base station. The base station will usually provide resources to the first UE for performing the uplink transmission. Specifically, the base station may transmit, to the first UE, a first uplink grant providing a first uplink transmission opportunity for an uplink transmission to the base station in a serving cell, the uplink transmission being associated with the transmission of an uplink transport block. For instance, the uplink transmission may be based on a dynamic grant or a configured grant. The base station may provide at least one serving cell to the first (and further) UE(s). Specifically, the base station may be capable of serving multiple UEs in a single serving cell. That the uplink transmission is associated with the transmission of an uplink transport block may be understood to mean that the uplink transmission comprises the (e.g. encoded) transport block. However, that the first UE performs the uplink transmission does not necessarily mean that it is received by the base station. Rather, the uplink transmission may generally be successful or unsuccessful.

The uplink transmission may be part of a vertical domain communication, an industrial internet of things, IIoT, communication, a vehicle to everything, V2X, communication, and/or an Ultra-Reliable Low-Latency Communication, URLLC. Accordingly, the transport block may be or be part of data to be transmitted in the context of such communication, i.e. in the context of vertical domains, the industrial internet of things, IIoT, a V2X communication, and/or URLLC.

When the first UE establishes the connection with the base station, the UE may transmit to the base station an indication for uplink re-transmission via another user equipment. While this information or indication may be provided as part of the connection setup, it may also be provided later on via dynamic signaling when needed, for instance by means of a new or existing MAC CE. Accordingly, the base station may receive, from the first UE the indication for uplink re-transmission via another user equipment. In an example, the indication for uplink re-transmissions via another UE may be a flag (e.g. a single bit) set by the first UE. In an example, the indication for uplink re-transmissions via another UE may be transmitted via RRC signaling, e.g. in an RRCReconfigurationComplete message or in an UEAssistanceInformation message. That the base station is aware of the first UE utilizing re-transmission via another UE, may influence the behavior of the base station with regard to the uplink grant for a re-transmission as will be explained in more detail below.

The uplink transport block may be or may be part of a payload to be sent to the base station. The uplink transport block may be or may be part of sensor data. The sensor data may be received by the first UE, e.g. from another device being or comprising a respective sensor. However, generally, the first UE may itself also be connected to another UE and receive the respective data and in particular the respective transport block from another UE (e.g. in a line of UEs). In other words, the first UE can but may not necessarily be the UE, which performed the initial or first uplink transmission for the uplink transport block. In any case, the first device may also comprise respective means for receiving respective sensor data.

As described, the first UE may establish a sidelink connection with the second UE. In an example, a sidelink connection may be understood as a direct connection between the first and second UE. In an example, a sidelink connection may be understood as a connection between the first and the second UE without a base station being involved. The sidelink connection between the first and second UE may comprise a control plane and/or a user plane connection. For instance, the sidelink connection may be a PC5 connection. For instance, a sidelink connection may be understood to be a sidelink connection according to the 3GPP standard, for instance as defined in the 3GPP technical specifications, such as TS23.287, TS37.985, TS38.885 and TS38.886. For instance, the sidelink connection may comprise SDAP, RRC, PDCP, RLC and/or MAC sublayers, and the physical layer.

The sidelink connection may be established and negotiated independently form a base station between the first and the second UE. Alternatively, the base station may also provide the first UE with information indicative of a sidelink resource allocation for sidelink communication between the first UE and the second UE. Accordingly, in an example, the base station may comprise means for transmitting, to the first UE, information indicative of a sidelink resource allocation for sidelink communication between the first UE and the second UE. For instance, the second uplink transmission opportunity may be time-coordinated with the sidelink resource allocation. This allows the first UE to provide necessary information to the second UE via the sidelink communication and the second UE to receive the necessary information in time for the re-transmission with the second uplink transmission opportunity.

As described, the first UE may then transmit (over the established sidelink connection), to the second UE, a re-transmission request for an uplink re-transmission to the base station in the serving cell by the second UE on behalf of the first UE, the uplink re-transmission being associated with the transmission of the uplink transport block. Accordingly, the second UE may receive, from the first UE, a re-transmission request for an uplink re-transmission to a base station in a serving cell by the second UE on behalf of the first UE, the uplink re-transmission being associated with the transmission of an uplink transport block.

While a re-transmission request may also be sent pre-emptively or precautionary, the re-transmission request will usually be sent to the second UE, in case there is a need for a re-transmission, the determination of which will be explained in more detail below. As the second UE is supposed to perform a re-transmission to the base station in the serving cell, the second UE will generally be required to be connected to the same serving cell of the base station. For this, the first and second UE may exchange required information, as will be explained further below.

That the uplink re-transmission is associated with the transmission of the uplink transport block is understood to mean that the uplink re-transmission may assist in the correct or error-free reception of the uplink transport block of the (original or previous) transmission at the base station. For this, the uplink re-transmission may for instance comprise the identically encoded uplink transport block or e.g. a differently encoded uplink transport block which may assist in receiving the originally encoded transport block and may e.g. constitute a redundancy version, as will be explained in more detail below.

That the uplink retransmission by the second UE shall be on behalf of the first UE may understood to mean that the first UE is the UE which is originally supposed to perform the uplink re-transmission of the uplink transport block and that it is the second UE that assists the first UE in achieving this task. In an example, the second UE may perform the uplink re-transmission on behalf of the first UE such that the base station may not even recognize that the uplink re-transmission is performed by a UE different from the first UE, as will be explained in more detail below. This case may also be referred to as transparent re-transmission.

In an example, the re-transmission request may be a dedicated message. For instance, the re-transmission request may be a message termed “RetransmissionRequestSidelink”. While in certain embodiments the re-transmission request may also imply a command for performing the re-transmission by the second UE, there may also be a dedicated re-transmission command, as will be explained in more detail below.

That the first UE requests the re-transmission from the second UE can but may not necessarily mean that the second UE actually performs the re-transmission. For instance, the second UE may itself be unsuccessful in performing the respective re-transmission. In an example, and specifically in said case, the second UE may itself request a further (e.g. third) UE to perform the respective re-transmission.

Thus, in an example, the second UE comprises means for, in case the uplink re-transmission by the second UE is unsuccessful, transmitting, to a third (or even further) UE, a further re-transmission request for a further uplink re-transmission to the base station in the serving cell by the third (or even further) UE on behalf of the first UE, the further uplink re-transmission being associated with the transmission of the uplink transport block. For the communication between the second and a third UE, the communication scheme (e.g. utilizing the described re-transmission request, re-transmission command and/or re-transmission acceptance messages) as described between the first and the second UE may be used.

As described, the first UE may transmit (over the established sidelink connection), to the second UE, context information to be used by the second UE for the uplink re-transmission. Accordingly, the second UE may receive, from the first UE, context information to be used by the second UE for the uplink re-transmission. The context information may provide the UE context of the first UE at least partially to the second UE. The second UE may then at least partially use the received context information for the uplink re-transmission. Examples of the context information are HARQ ReTX ID provided by the gNB, redundancy version, uplink grant/resources for retransmission, primary L1+L2 IDs, C-RNTI, which will be discussed further below in more detail.

Generally, the first UE may receive an uplink grant from the base station in order to perform a corresponding uplink re-transmission. Accordingly, the base station may transmit, to the first UE, a second uplink grant providing a second uplink transmission opportunity for an uplink re-transmission to the base station in the serving cell, wherein the uplink re-transmission is associated with the transmission of the uplink transport block. Therein, the time separation between the transmission (or provision) of the second uplink grant and the second uplink transmission opportunity for uplink re-transmissions via another UE may be adjusted based on the respective indication as reported by the first UE. For instance, the uplink transmission opportunity is delayed so as to allow for the uplink re-transmission by another UE on behalf of the first UE. That the uplink transmission opportunity is delayed may be understood to mean that the uplink transmission opportunity is delayed compared to a situation in which the first UE has not informed the base station that the first UE contemplates or considers a (potential) uplink re-transmissions via another UE.

As described, the first UE may transmit (over the established sidelink connection), to the second UE, uplink data to be used by the second UE for the uplink re-transmission. Accordingly, the second UE may receive, from the first UE, uplink data to be used by the second UE for the uplink re-transmission. The uplink data may for instance be sent together with the context information in a common message or separately in separate messages. As described, the uplink data may enable the second UE to re-transmit the transport block as originally encoded or encoded differently for instance. The encoding may take place at the first UE or at the second UE.

In any case, the second UE may then perform the uplink re-transmission to the base station in the serving cell on behalf of the first UE. Accordingly, the base station may receive, from the second UE, the uplink re-transmission on behalf of the first UE. The uplink re-transmission may also be referred to as redundant or assisted re-transmission. For this, the second UE may use at least in part the received context information and the received uplink data, as described above. As already mentioned, the second UE may in turn also encounter issues when performing the uplink re-transmission. In that case, the second UE itself may then perform the actions as described for the first exemplary aspect and the first UE and utilize a further (e.g. third) UE for a further uplink re-transmission. As also mentioned above, by performing the uplink retransmission on behalf of the first UE, the base station may or may not recognize that the uplink re-transmission is performed by a UE other than the first UE.

In an example, the re-transmission of the uplink transmission is part of or is a hybrid automated repeat request. HARQ, scheme. For instance, the employed HARQ scheme for the transmission and respective retransmissions may be Type I HARQ. Type II HARQ, or HARQ with soft combining utilizing e.g. chase combining or incremental redundancy.

The above (and in more detail further below) described approach improves the scenario where multiple UEs are deployed to transmit redundant data over the air interface to the same base station. The base station eliminates the duplicates and forwards the data further (e.g. to the user plane function, UPF). Thereby, a single point of failure at the UE is avoided and the link reliability against failures that may happen e.g. due to handover failures or blockages is enhanced. At the same time, the improvement in reliability is achieved efficiently with only minimal need for resources particularly in case of successful transmissions.

In an example, the first UE further comprises means for determining a need for the uplink re-transmission.

For instance, the need for the uplink re-transmission may be based on a number of (e.g. 1, 2, 3 or even more) negative feedbacks or negative acknowledgements from the base station (e.g. associated with the uplink transmission or re-transmissions, or with past transmission or re-transmissions). For instance, the first UE may receive one or more NACKs from the base station. For instance, in case a predetermined number of NACKs is received by the first UE for one or more uplink transmissions or re-transmissions, it may be determined that there is a need for an uplink re-transmission via a second UE via a sidelink connection. Thus, it is noted that the first UE may also try to perform a re-transmission on its own before considering the described re-transmission via a sidelink connection and a second UE.

Additionally or alternatively, the need for the uplink re-transmission may be based on a worsening of one or more channel properties between the first UE and the base station. For instance, the channel state information, CSI, may be used for determining the channel property. In case the channel properties worsens, the first UE may determine a need for the uplink re-transmission from a second UE (connected to the first UE) via a sidelink connection.

Additionally or alternatively, the need for the uplink re-transmission may be based on a decrease of the signal to interference plus noise ratio, SINR of one or more radio signals received by the first UE from the base station, for instance one or more reference downlink signals such as SSB or CSI-RS or DM-RS signals. For instance, in case the SINR falls below a predefined threshold, it may be determined that there is a need for an uplink re-transmission from a second UE (connected to the first UE) via a sidelink connection.

Additionally or alternatively, the need for the uplink re-transmission may be based on a decision from a higher layer for an uplink re-transmission. For instance, the UE may be instructed by the RRC layer to initiate an uplink-retransmission via a second UE via a sidelink connection. The reception of such instructions may also be considered to be a determination of a need for a respective uplink re-transmission via a sidelink connection.

In an example, at least one of the context information and the uplink data are transmitted pre-emptively before having determined a need for the uplink re-transmission. For instance, uplink data and/or the context information (or a part thereof) is transmitted pre-emptively each time irrespective of whether it has been determined that an uplink re-transmission is actually to be performed. In a preferred example, this is advantageous specifically for the uplink data, as the uplink data is usually available as soon as the (original) transmission has been sent by the first UE. The context information may at that time not yet be completely available, as the first UE may not yet be informed of specifics (e.g. the resource allocation) for the uplink re-transmission. However, other context information regarding the UE context may already be available and transmitted pre-emptively. This may be advantageous specifically in case there are very stringent requirements for the uplink re-transmission occasions and latency. Thus, the described pre-emptive forwarding over a sidelink connection regardless of e.g. a feedback of the base station improves the communication latency, as the second UE will always have the uplink data readily available for the uplink re-transmission if any.

The first UE may transmit the uplink data for the uplink re-transmission before, in parallel or subsequently to the (original) uplink transmission of the first UE to the base station. For instance, the first UE may have multi-transmission (multi-TX) front-end capabilities. The UE may then transmit to the base station in the uplink (the uplink transmission) and also to the second UE via the sidelink connection (the uplink data for the uplink re-transmission) simultaneously, at least for different frequency bands. In case the UE has single-transmission (single-TX) front-end capabilities, the UE may transmit to the base station in the uplink (the uplink transmission) and also to the second UE via the sidelink connection (the uplink data for the uplink re-transmission) subsequently (e.g. first to the base station and then to the second UE or vice versa).

For transmitting the uplink data pre-emptively to the second UE, but also in general, a data transmission from the first UE to the second UE (or vice versa) may use a physical sidelink shared channel, PSSCH.

In an example, the re-transmission request comprises an identifier of the serving cell or information indicative thereof. For instance, a cell identifier for the serving cell may be a cell identity, such as the CI, PCI, ECI or NCI.

The identifier may also be a globally unique identifier such as the ECGI or NGCI. The identifier of the serving cell may advantageously be used by the second UE to determine whether the second UE is connected to the same serving cell as the first UE. In response thereto, the second UE may accept or reject the re-transmission request (as will be detailed below).

Additionally or alternatively, the re-transmission request comprises a remaining delay budget related to the uplink transport block or information indicative thereof. An example of a remaining delay budget is a packet delay budget, PDB. A (packet) delay budget may be understood as an upper bound for the time that data (e.g. a packet) may be transmitted from the UE to e.g. the policy and charging enforcement function, PCEF or the user plane function, UPF. In one example, the second UE may reject the re-transmission request in case the second UE cannot fulfil or guarantee the remaining delay budget indicated in the re-transmission request.

Additionally or alternatively, the re-transmission request comprises a size of the uplink data or information indicative thereof. For instance, the re-transmission request may comprise a size in bits, resource elements, resource blocks or the like.

Additionally or alternatively, the re-transmission request comprises a quality of service, QOS, for the transmission of the uplink transport block or information indicative thereof. The second UE may for instance check whether it is able to fulfil the stipulated QoS requirement.

One or more of the above information may be used by the second UE in particular for determining whether it accepts or rejects the re-transmission request of the first UE.

Thus, in an example, the first UE comprises means for, in response to the re-transmission request, receiving, from the second UE, an indication as to whether the re-transmission request is accepted. The second UE may signal to the first UE that the re-transmission request is accepted in a dedicated message, which may be termed “RetransmissionRequestSidelinkAccept”, for instance. The second UE may signal to the first UE that the re-transmission request is rejected in a dedicated message, which may be termed “RetransmissionRequestSidelinkReject”, for instance.

For instance, in case the second UE indicates that the re-transmission request is accepted, the first UE may perform the transmission of at least one of the context information and the uplink data to the second UE. For instance, the first UE may transmit the context information and the uplink data in a common message (e.g. a message termed “RetransmissionCommandSidelink”), which may also be interpreted by the second UE as an instruction for the second UE to perform the uplink re-transmission based on the provided information. In case the first UE has transmitted the uplink data preemptively, the UE may transmit the uplink data in separate messages preemptively and then, in case of a determined need for an uplink re-transmission, transmit the context information in a separate message without the uplink data (e.g. in said “RetransmissionCommandSidelink” message), which message may also in this case be interpreted by the second UE as an instruction for the second UE to perform the uplink re-transmission with the provided information.

For example, in case the second UE indicates that the re-transmission request is denied, the first UE may transmit, to a third (or even further) UE, a further re-transmission request for a further uplink re-transmission to the base station in the serving cell by the third UE on behalf of the first UE, the further uplink re-transmission being associated with the transmission of the uplink transport block. For example, the first UE may continue to send re-transmission request messages to UEs until a UE accepts the re-transmission request of the first UE. Generally, it may also be possible that more than one UE accepts the re-transmission request and that the first UE uses more than one other UEs for the uplink re-transmission. In case a UE denies or rejects a re-transmission request of the first UE, the first UE may refrain from transmitting the context information and/or the uplink data to the respective UE.

As already mentioned, the first UE may further comprise means for transmitting, to the second UE, a re-transmission command instructing the second UE to perform the uplink re-transmission. The re-transmission command may be interpreted by the second UE as an instruction to perform the re-transmission with the provided information. Accordingly, the re-transmission command may comprise all the information, which may not yet have been transferred to the second UE (such as pre-emptively transmitted uplink data) for performing the uplink re-transmission.

For instance, the re-transmission command comprises at least one of the context information and the uplink data. In an example, the re-transmission command comprises both, the context information and the uplink data. In another example, the transmission command comprises only the context information, as the uplink data may in particular have been transmitted previously.

In an example, the uplink data transmitted to the second UE is the uplink transport block. The second UE will then need to encode the uplink transport block. The second UE may use the received context information for the encoding. Alternatively, the uplink data transmitted to the second UE is an uplink codeword already encoded in accordance with the context information, for instance a particular redundancy version associated with the uplink transport block. In this case, the second UE will not need to encode the uplink data but receives already encoded uplink data.

In an example, the context information comprises information indicative of a UE identifier assigned by the base station in the serving cell. Additionally or alternatively, the context information may comprise information indicative of an uplink grant for the uplink re-transmission. Additionally or alternatively, the context information may comprise information indicative of uplink resources to be used for the uplink re-transmission. Additionally or alternatively, the context information may comprise information indicative of a re-transmission process identifier to be used for the uplink re-transmission. For instance, the context information may comprise a HARQ process identifier. Additionally or alternatively, the context information may comprise information indicative of a redundancy version to be used for the uplink re-transmission. This information may be used for encoding the transport block and/or for informing the base station of the used redundancy version.

In an example, the sidelink connection is established with the second UE based on an application to which the uplink transport block pertains. For instance, in case the UE determines that the corresponding application requires a high reliability and/or low latency (e.g. by means of the application ID) the UE establishes a sidelink connection with a second UE (and optionally also with further UEs) in the communication range of the first UE.

Additionally or alternatively, the sidelink connection is established with the second UE based on a certain required quality of service. QoS, for the transmission of the uplink transport block. For instance, the first UE may determine that a certain quality of service. QoS, is required (which may also be indicated by the application or by a higher layer, for instance), e.g. a QoS above a certain threshold, the first UE establishes a sidelink connection with a second (and potentially further) UEs.

Additionally or alternatively, the sidelink connection is established with the second UE based on a decision from a higher layer, in particular a network layer, such as a NAS layer.

Generally, the UE may decide internally based on proprietary criteria whether a sidelink connection is to be established.

In an example, the first UE may comprise means for transmitting, to the base station, information indicative of a delay required between the transmission (or provision) of the second uplink grant and the second uplink transmission opportunity for the uplink re-transmission. Accordingly, the base station comprises means for receiving, from the first UE, information indicative of a delay required between the transmission (or provision) of the second plink grant and the second uplink transmission opportunity for the uplink re-transmission. The delay may be a proposed or preferred or recommended delay of the first UE. In one example the base station may use the indicated delay (or a longer delay) between the second uplink grant and the second uplink transmission opportunity. In an example, the base station may nevertheless use a shorter or longer delay between the second uplink grant and the second uplink transmission opportunity. The delay may also be a minimum delay. The base station may in this case only use the minimum delay or a longer delay. The delay may for instance indicate the time delay with respect to the transmission (or provision) of the uplink grant for the re-transmission.

In an example, the information indicative of a required delay between the transmission of the second uplink grant and the second uplink transmission opportunity for the uplink re-transmission is received at the base station via RRC signaling. As described with respect to the indication from the UE for uplink re-transmission via another user equipment, the information indicative of the delay may also be provided in an RRCReconfigurationComplete message or an UEAssistanceInformation message.

It is to be understood that the presentation of the embodiments disclosed herein is merely by way of examples and non-limiting.

Herein, the disclosure of a method step shall also be considered as a disclosure of means for performing the respective method step. Likewise, the disclosure of means for performing a method step shall also be considered as a disclosure of the method step itself.

Other features of the present disclosure will become apparent from the following detailed description considered in conjunction with the accompanying drawings. It is to be understood, however, that the drawings are designed solely for purposes of illustration and not as a definition of the limits of the present disclosure, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1a-b show schematic diagrams illustrating example systems with alternative solutions for comparison;

FIG. 2 shows a schematic diagram illustrating an example radio environment in which exemplary embodiments of the present disclosure may be performed;

FIG. 3 shows a flow diagram of an example embodiment of the exemplary first aspect;

FIG. 4 shows a flow diagram of an example embodiment of the exemplary second aspect;

FIG. 5 shows a flow diagram of an example embodiment of the exemplary third aspect;

FIG. 6a,b show schematic diagrams illustrating an example system with a first UE a second UE and a base station according to the different aspects;

FIG. 7-10 show exemplary signaling charts illustrating different example embodiments of the various aspects;

FIG. 11 shows a schematic diagram illustrating a block diagram of an exemplary embodiment of an apparatus according to the present disclosure;

FIG. 12 shows a block diagram of an exemplary embodiment of a base station; and

FIG. 13 shows a schematic illustration of examples of tangible and non-transitory computer-readable storage media.

The following description serves to deepen the understanding of the present disclosure and shall be understood to complement and be read together with the description of example embodiments of the present disclosure as provided in the above SUMMARY section of this specification.

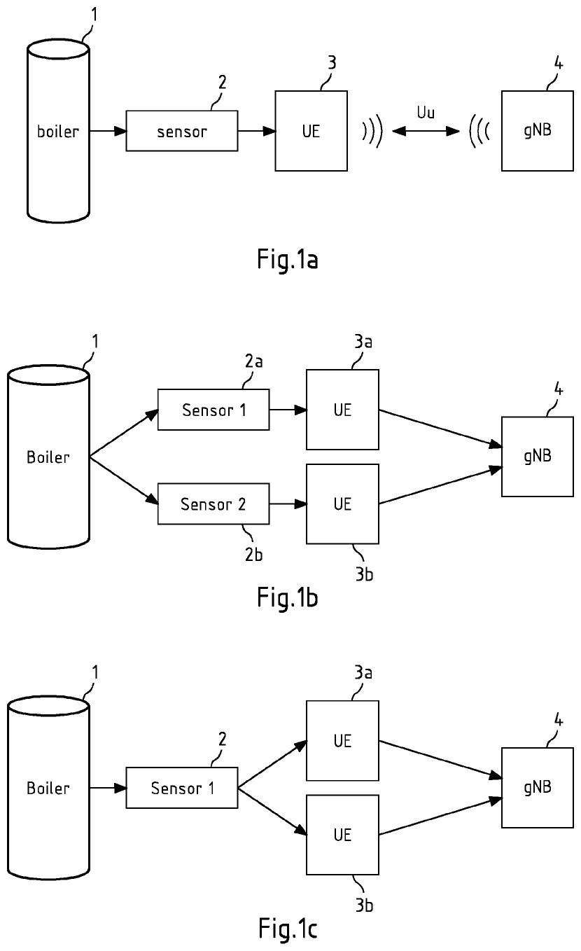

FIG. 1a)-c) show schematic diagrams illustrating example systems incorporating redundancy with alternative solutions for comparison with the present disclosure.

FIG. 1a) shows an example scenario where a UE 3 in an industrial environment (such as a manufacturing hall) is connected to a sensor 2 of an industrial appliance 1 (in this non-limiting example a boiler) and transmit this sensor's data to an eNB/gNB 4 in an URLLC scenario. Due to the very nature of wireless transmission over a fading channel, the single wireless link Uu in FIG. 1a) is a single source of failure and prone to packet errors.

As shown in FIGS. 1b) and c), a way to approach the above problem would be to add redundancy to meet the reliability requirements by simply duplicating the wireless link. In FIG. 1b) there are two redundant sensors 2a, 2b and two redundant UEs 3a, 3b, while in FIG. 1c) only the UE is made redundant. In either case, the UEs transmit in parallel the very same sensor data over the respective additional wireless links. However, while this added redundancy comes with an increased reliability, it also comes with increased energy consumption, latency and spectral resources. Specifically, in case a packet is successfully decoded, the additional resources (e.g. radio resources, energy) spent for transmitting the redundant packet over the redundant Uu radio connection is wasted.

In the following an, an example communication system, in which the present disclosure may be applied. While the specific radio system in the examples below is a 5G system, this is only to be considered a non-limiting example.

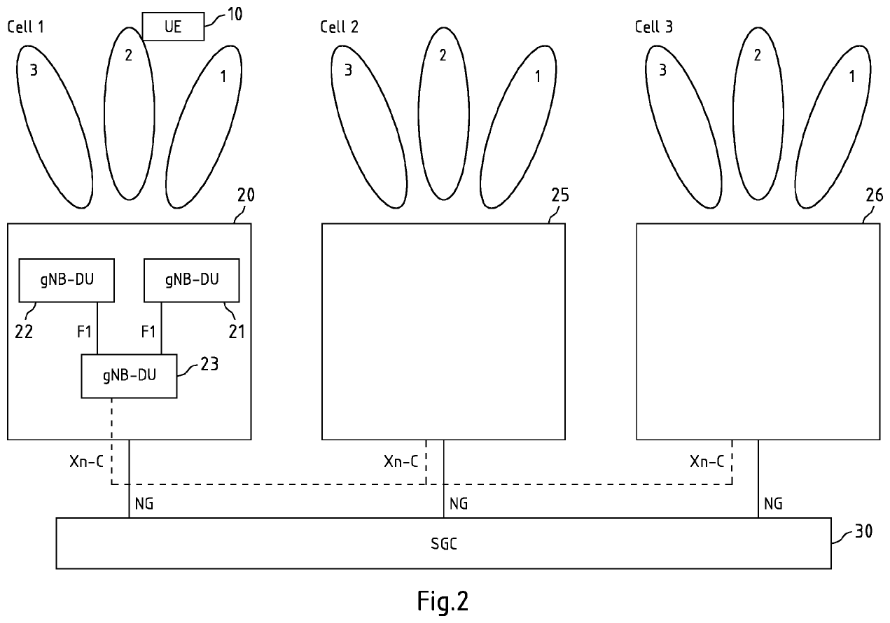

More specifically, FIG. 2 shows a 5G communication network, which introduces the New Radio technology and also an architecture for which the different sublayers of the RAN may be split into two logical entities in a communication network control element (like a BS or gNB), which are referred to as distributed unit (DU) and central unit (CU). For example, the CU is a logical node that controls the operation of one or more DUs over a front-haul interface (referred to as F1 interface). The DU is a logical node including a subset of the gNB functions, depending on the functional split option.

As shown in FIG. 2, a user equipment (UE) 10, as an example of a user equipment of the first exemplary aspect of the present disclosure, is connected to a cell 1 of a base station, a gNB 20 via a communication beam of the cell 1. In the example shown in FIG. 2, the gNB 20 is provided with a CU 23 and two DUs 21 and 22 being connected to the CU 23 by a F1 interface. Furthermore, as shown in the example of FIG. 2, there is a plurality of further cells to which the UE 10 can connect. Naturally, in each cell, a plurality of UEs may be present and connected to the respective cell. Similarly to cell 1, cells 2 and 3 are controlled by gNB 25 and 26, respectively, and each provides a plurality of beams 1 to 3. The different beams of a 5G network may be used for beam diversity or beam hopping. As shown in FIG. 2, each base station or gNB of the cells is connected to a core network, such as a 5GC, via respective interfaces, indicated as NG interfaces. Furthermore, each gNB of the cells is connected with each other by means of a specific interface, which is referred to e.g. as an Xn-C interface. Any of these network entities, such as the gNB, gNB-DU, gNB-CU and/or 5GC, may individually or together be an example of a base station or a part thereof according present disclosure.

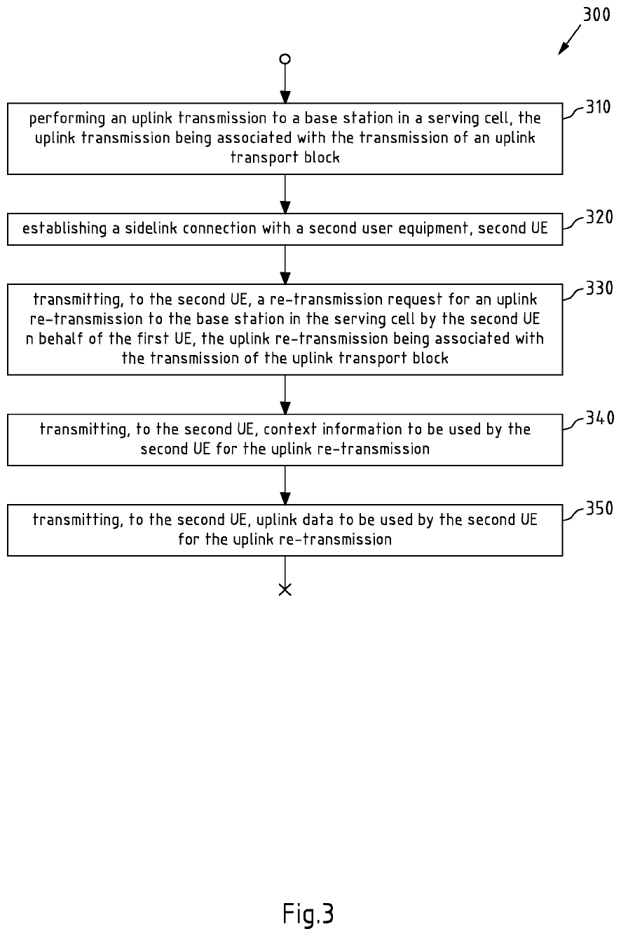

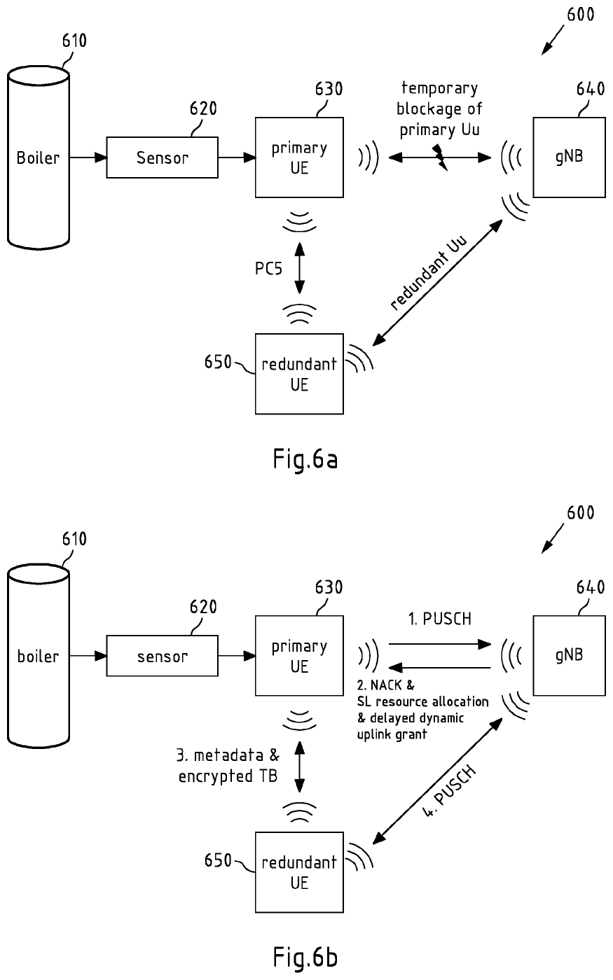

The exemplary aspects of the present disclosure will now be explained in more detail with respect to the flow diagrams 300, 400 and 500 of FIGS. 3. 4 and 5 in combination with the system schematically illustrated in FIG. 6. It is noted that the order of the steps in FIGS. 3-5 can be but do not need to be performed in the presented order.

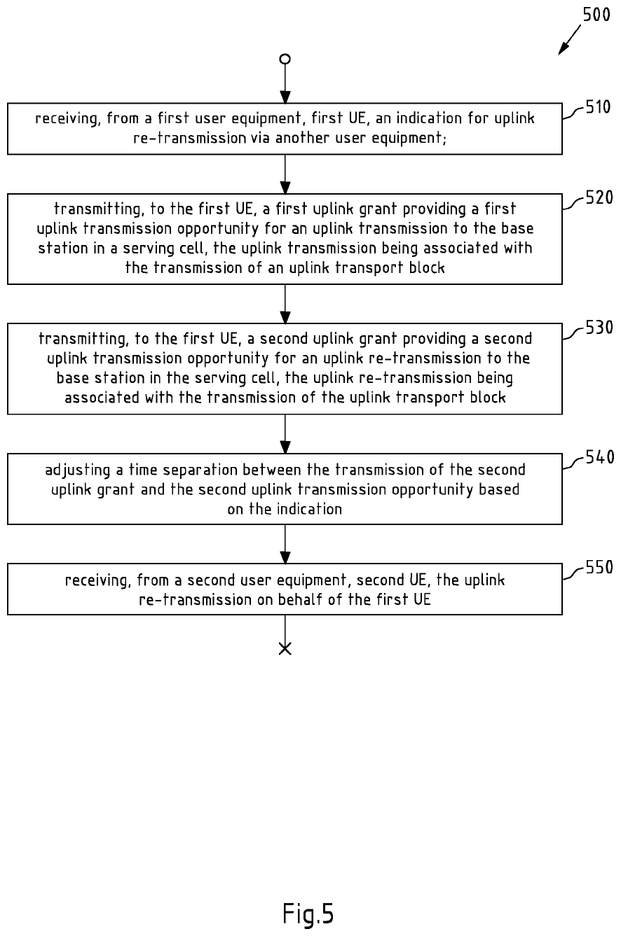

In the example embodiment shown in FIG. 6a), a first UE 630 (also referred to as primary UE) has to transmit ultra-reliable packets to a base station 640 (in the example a gNB). In this example, the packets pertain to sensor data from sensor 620 of a boiler 610 (as a non-limiting example of an IIoT device). For this, the first UE 630 establishes a connection with the gNB 640. The first UE 630 also transmits to the gNB 640 an indication for (potential) uplink re-transmission via another user equipment (cf. action 510 of FIG. 5). Furthermore, the first UE 630 also establishes a sidelink or PC5 connection to a second UE 650 or even a plurality or a set of second UEs (also referred to as redundant UE(s)) in its vicinity. A respective second UE 650 is illustrated in FIG. 6 and has a redundant Uu connection to the gNB 640.

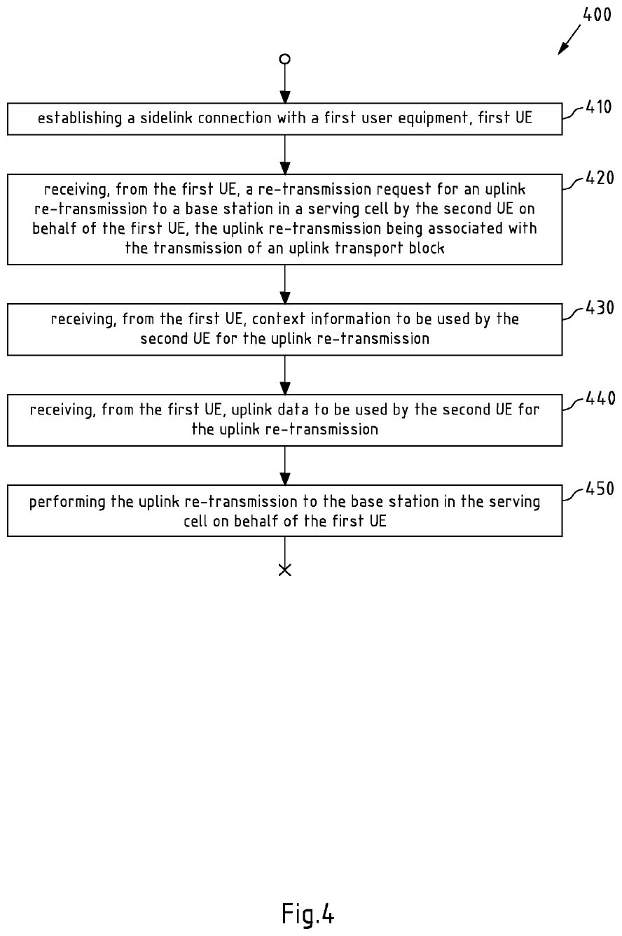

The first UE 630 may establish a sidelink connection with the second UE (cf. action 320 of FIG. 3 and action 410 of FIG. 4). The trigger to establish the sidelink connection may be based on (but not limited to) an application ID of the application to which the packets pertain, a QoS requirement and/or a NAS/higher layer (e.g. application layer) instruction. Alternatively, it may be up to first device (primary UE) whether to establish a respective sidelink connection.

The base station transmits, to the first UE, a first uplink grant providing a first uplink transmission opportunity for an uplink transmission to the base station in the serving cell of the base station (cf. action 520 in FIG. 5). The UE may use this grant and the uplink transmission opportunity to perform a respective uplink transmission an uplink transport block (i.e. the transport block the transmission from action 310 in FIG. 3). However, there may be a (temporary) worsening or blockage of the connection between the first UE 630 and the gNB 640, as illustrated in FIG. 6a). Accordingly, the first UE determines that the uplink transmission(s) (cf. action 310 in FIG. 3) from the first UE 630 to the gNB 640 is/are error-prone, have not been received and/or can (potentially) not fulfil a requirement on reliability, e.g. because the first UE 630 receives a NACK from the gNB 640 in response to the PUSCH transmission, as illustrated in FIG. 6b). The gNB 640 transmits to the first UE 630 a second uplink grant providing a second uplink transmission opportunity to the base station in the serving cell, the uplink re-transmission being associated with the transmission of the uplink transport block (cf. action 530 in FIG. 5). Therein, the base station has adjusted a time separation between the transmission of the second uplink grant and the second uplink transmission opportunity based on the indication provided by the UE (action 540 of FIG. 5) and the uplink transmission opportunity will be sufficiently delayed so as to provide enough time to allow for the sidelink communication and the subsequent uplink re-transmission by the second UE 650.

Specifically, the first UE 630 sends a RetransmissisonRequestSidelink message over the established sidelink to the second UE 650 (cf. actions 330 of FIG. 3 and action 420 of FIG. 4). As described, the trigger to send a RetransmissisonRequestSidelink message may for instance be based on a negative HARQ feedback from the gNB (e.g. configurable number of NACKs), but it may also be triggered by a worsening CSI, an increasing SINR (leading to reduced MCS), and/or a higher layer decision.

Alternatively, the first UE 630 may also have sent this RetransmissisonRequestSidelink message proactively or pre-emptively, i.e. already before the first UE 630 even starts sending payload data in uplink and thus before noticing that the uplink transmission may be error-prone. The proactive request may in particular be beneficial in time critical scenario.

The first device (primary UE) furthermore needs to make sure that the selected second UE is in the same cell. In the example, this is done by announcing a cell identifier, e.g. the NCI, PCI and/or cell ID, in the RetransmissisonRequestSidelink. In case the second UE is attached to another cell will reject the re-transmission request of the first UE by responding with a RetransmissionRequestSidelinkReject.

In case the second UE accepts the re-transmission request of the first UE (e.g. by responding with a RetransmissionRequestSidelinkAccept), the first UE 630 will transmit a UE context and uplink data to the second UE 650 to be used for the uplink re-transmission (cf. actions 340, 350 in FIG. 3 and actions 430, 440 in FIG. 4). The second UE 650 can then perform the uplink re-transmission to the gNB 640 in a further PUSCH transmission, as indicated in FIG. 6 (cf. action 450 of FIG. 4 and action 550 in FIG. 5).

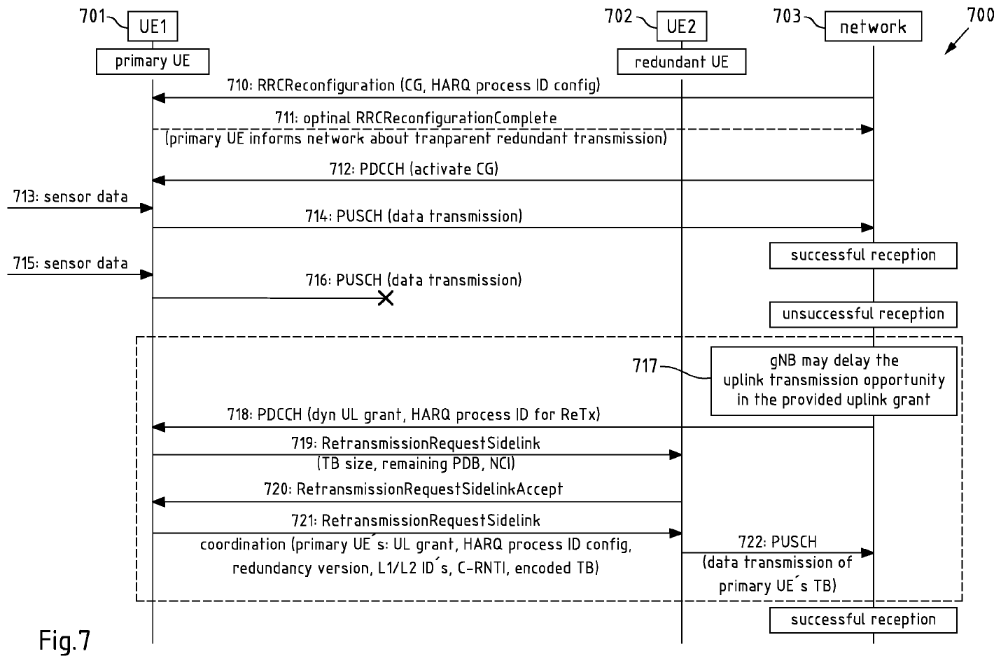

Further example embodiments of the different aspects will now be described with respect to the signalling charts in FIGS. 7-10.

FIG. 7 shows a signalling flowchart 700 for the case of an unsuccessful reception of a PUSCH transmission of a first UE 701 at the gNB 703 (causing a NACK feedback from the gNB). The gNB will indicate the unsuccessful reception to the primary UE 701 by providing a dynamic uplink grant for the retransmission.

In more detail, the gNB 703 sends a RRCReconfiguration message with a configured grant, CG, and a HARQ process ID config to the first UE 701 (action 710). The first UE 701 optionally confirms with an RRCReconfigurationComplete message informing the network about the transparent redundant transmission (action 711). The first UE 701 activates the configured grant via PDCCH (action 712). The first UE obtains sensor data (action 713) and successfully transmits the data in a PUSCH uplink transmission to the gNB 703 (action 714). The first UE again obtains sensor data (action 715) and unsuccessfully transmits the data in a PUSCH uplink transmission to the gNB 703 (action 716).

The gNB 703 provides a (dynamic) uplink grant indicating an uplink transmission opportunity for the uplink re-transmission via PDCCH, also comprising the HARQ process ID for the re-transmission the (action 718). In one embodiment the gNB intentionally delays the transmission opportunity provided by the dynamic grant in order to allow enough time for the additional sidelink communication (action 717). Since the gNB also provides the sidelink resource allocation (at least in sidelink mode 1) the gNB may infer from the provided sidelink mode 1 resources the timing for the UL grant.

Instead of performing the retransmission(s) itself, the first UE 701 delegates the retransmission(s) to the second UE 702 in a RetransmissionRequestSidelink message in this case comprising the size of the transport block TB of the uplink transmission, the remaining packet delay budget PDB, and the NR cell identifier, NCI (action 719). The second UE 702 may either accept or reject the request to perform the retransmission on behalf of the first UE 701. Specifically the NCI is used by the second UE 702 to check whether it belongs to same cell as the first UE 701. In this example, this check only occurs after respective NACK receptions from the gNB 703.

In the illustrated case of acceptance, the second UE sends a RetransmissionRequestSidelinkAccept message (action 720) and, in response, the first UE 701 forwards all necessary UE context information or meta data (in this case the HARQ ReTX ID provided by gNB, the redundancy version, uplink grant/resources for the uplink re-transmission, the primary L1+L2 IDs, the C-RNTI) to the accepted second UE 702 in a RetransmissionCommandSidelink message (action 721). Alongside the mentioned context information or metadata, the first UE 701 also forwards its encoded transport block (generated by the first UE 701) either containerized in the RetransmissionCommandSidelink (action 721) or over a separate PSSCH transmission to the second UE 702. Thus, the second UE 702 can perform the uplink re-transmission on behalf of the first UE 701 and make this retransmission appear to the gNB 703 as if it would originate from the first UE 701 (action 722).

The retransmission performed by the second UE 702 exploits the different channels conditions as the second UE 702 has a different path over the air to the gNB 701, however the second UE 702 makes the uplink re-transmission look as if it would have been transmitted by the first UE 701.

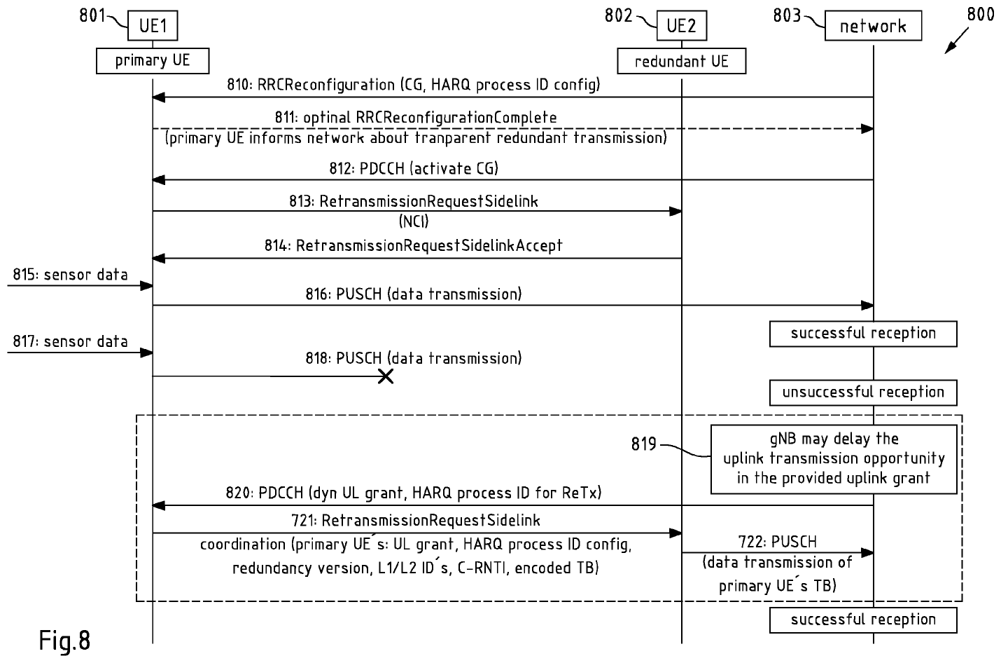

Referring now to the signalling flowchart 800 of FIG. 8, an example embodiment is shown in which the signalling procedure with the RetransmisisonRequestSidelink message is performed prior to the initial uplink transmission by the primary UE 801 (or at least prior to a negative acknowledgement of the gNB 803).

Similarly to the example in FIG. 7, in FIG. 8 the gNB 803 sends a RRCReconfiguration message to the first UE 801 (action 810) and the first UE 801 optionally confirms with an RRCReconfigurationComplete message informing the network about the transparent redundant transmission (action 811). The first UE 801 activates the configured grant via PDCCH (action 812).

In contrast to the previous example of FIG. 7, the first UE 801 already now transmits a RetransmissionRequestSidelink message to the second UE 802, in this case comprising the NR cell identifier, NCI (action 813). Again, the second UE 802 may either accept or reject the request to perform the retransmission on behalf of the first UE 801, in particular based on the provided NCI by checking whether the second UE 802 belongs to same cell as the first UE 801. In this example, this check already occurs before any respective NACK receptions from the gNB 803 and also before any uplink transmission of the first UE 801.

In the illustrated case of acceptance, the first UE 801 performs the uplink transmissions based on the sensor data as before (actions 815, 816, 817) until it determines the need for a re-transmission after an unsuccessful PUSCH transmission (action 818).

The gNB 803 again delays the transmission opportunity for the re-transmission in order to allow enough time for the additional sidelink communication (action 819) and provides the first UE 801 via PDCCH signalling with a respective (dynamic) uplink grant for the uplink re-transmission and the HARQ process ID for the re-transmission (action 820).

As before, the first UE 801 then forwards all necessary UE context information or meta data (HARQ ReTX ID, the redundancy version, uplink grant/resources for the uplink re-transmission, the primary L1+L2 IDs, the C-RNTI) and the encoded transport block to the second UE 802 in a RetransmissionCommandSidelink message (action 821).

Thus, the second UE 802 can perform the uplink re-transmission on behalf of the first UE 801 and make this retransmission appear to the gNB 803 as if it would originate from the first UE 801 (action 822).

The embodiment of FIG. 8 is specifically advantageous for latency stringent use cases. Since the signalling procedure of the RetransmisisonRequestSidelink message is performed prior to any initial uplink transmission by the first UE 801 (effectively saving the RetransmissionRequestSidelink and RetransmissionRequestSidelinkAccept messages, actions 719, 720 in FIG. 7 after the PUSCH uplink transmission failure), the re-transmission via the second UE 802 may be performed particularly quickly.

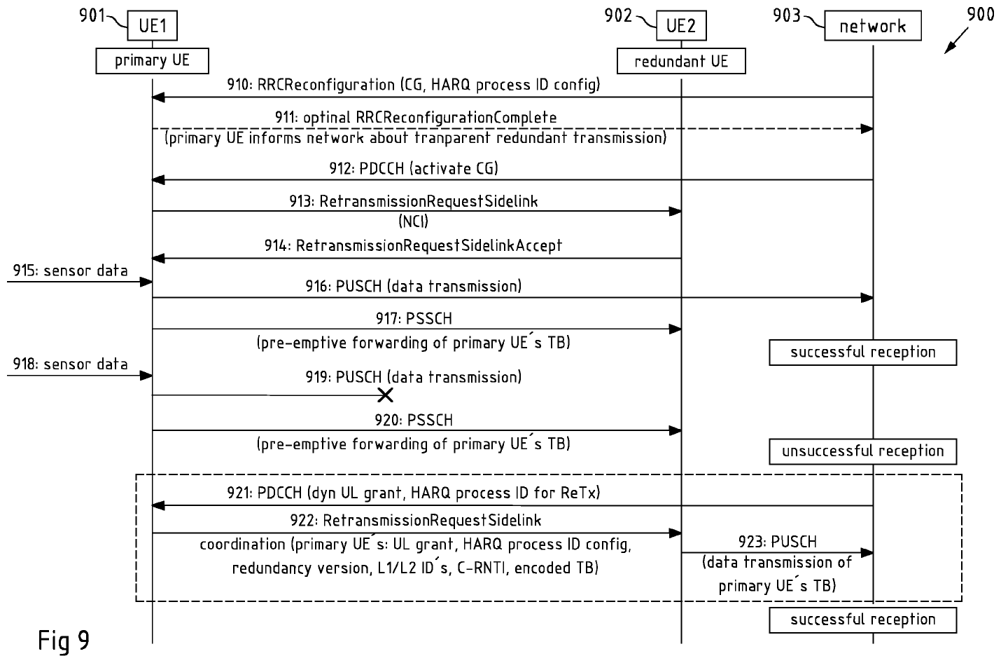

Turning now to the signalling flowchart 900 of FIG. 9, there is illustrated an example embodiment, in which the forwarding of the (encoded/encrypted) uplink data or pay load of the first UE 901 over the sidelink connection to the second UE 902 may be done in a pre-emptive way, i.e. always forwarding the primary UEs' transport blocks over the sidelink connection regardless the gNB's 903 feedback or another determined need for an uplink re-transmission.

With respect to the actions 910-914 of FIG. 9 it can be referred to the description of actins 810-814 of FIG. 8. However, in contrast to the example of FIG. 8, the first UE 901 in the example of FIG. 9, pre-emptively forwards uplink data associated with the uplink transmission (in this case the transport block of the uplink transmission) to the second UE 902 (actions 915, 916, 917 and 918, 919, 920).

That may be beneficial in case the uplink transmission sets very stringent requirements on the uplink re-transmission occasions and latency. However the drawback is that this would increase the resource utilization over the sidelink connection due to those of the pre-emptively forwarded transport blocks, for which no re-transmission is necessary. In other words, for cases in which there is the risk that the gNB 903 expects and grants the re-transmission for the given HARQ configuration before the primary UE 901 can forward its context information/meta-data and the transport block (after it has received the respective NACK feedback for the initial transmission), the pre-emptive forwarding over the sidelink regardless of the gNB's 903 feedback (so before the new data indicator, NDI, bit is toggled) can provide more and sufficient time to transfer the first UE's 901 context information/meta-data and transport block over the sidelink connection. This may be particularly advantageous for use cases with e.g. a small remaining delay budget (PDB).

With respect to actions 921, 922, 923 it can again be referred to actions 820, 821, 822 of FIG. 8 with the difference, that the RetransmissionCommandSidelink message in FIG. 9 (action 922) does not comprise the encoded TB, as it was already forwarded pre-emptively. Rather, upon reception of the NACK message from the gNB 903 (NDI bit toggled, action 921), the primary UE 901 only needs to trigger the re-transmission by a short command message (action 922).

In the embodiment of FIG. 9, in case the first UE 901 has multi-TX front-end capabilities and the uplink and sidelink transmission are allocated in different frequency bands, the first UE 901 may transmit uplink transmissions and sidelink transmissions in parallel. In case the first UE 901 has a single TX front-end, the first UE 901 may pre-emptively transmit the transport block (actions 917, 920) via the sidelink connection (i.e. before the gNB 903 feedback) right after the respective uplink transmission (actions 916, 919).

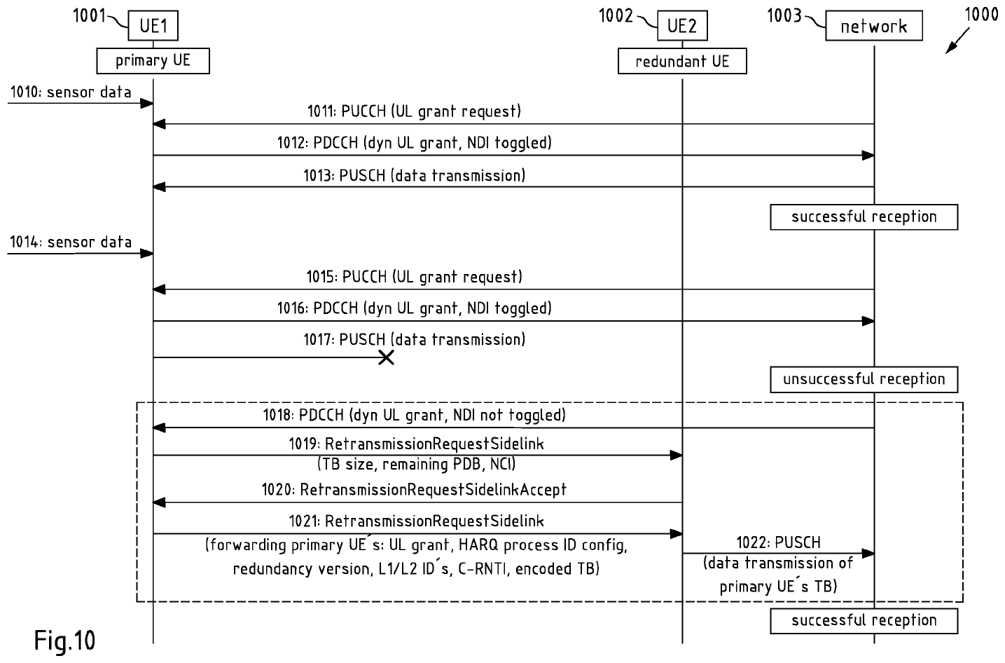

Turning now to the signalling flowchart 1000 of FIG. 10, there is illustrated an alternative option for granting the uplink resources. The embodiments of FIGS. 7-9 utilize a configured grant, CG (cf. actions 710, 810, 910). Though this may introduce some signalling overhead, as the CG is activated and released every time a (re-) transmission is needed. In contrast, FIG. 10 illustrates the use of dynamic grants also for the uplink transmission of the first UE 1001. More specifically, the first UE 1001 requests an UL grant via PUCCH (actions 1011, 1015), when new sensor data arrives at its buffer (actions 1010, 1014). The first UE 1001 will then receive a dynamic UL grant (NDI toggled indicating that new data is expected) via PDCCH (actions 1012, 1016) so that the uplink transmission can be performed via PUSCH (actions 1013, 1017). With respect to actions 1018-1022 it can be referred e.g. to actions 718-722. This scheme may also be employed in the embodiments of FIG. 7-9.

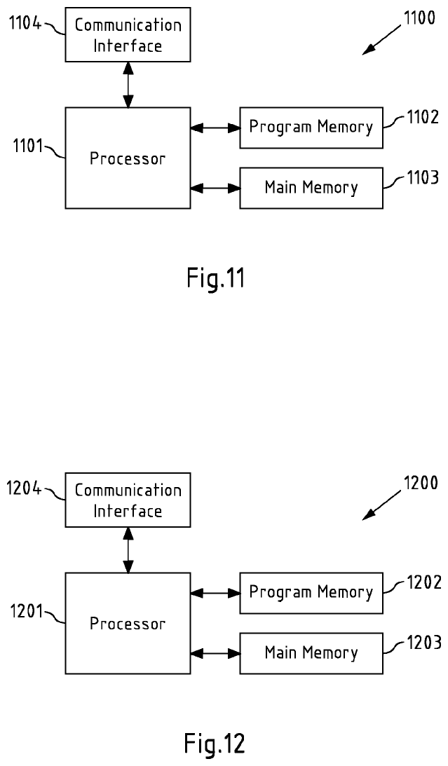

Turning now to FIG. 11, there is shown a block diagram of an exemplary embodiment of a UE 1100 according to the present disclosure, such as UE 10, 701, 702, 801, 802, 901, 902, 1001, 1002 of FIGS. 2, 7-10. For example, UE 1100 may be one of a smartphone, a tablet computer, a notebook computer, a smart watch, a smart band, an IoT device or a vehicle or a part thereof.

UE 1100 comprises a processor 1101. Processor 1101 may represent a single processor or two or more processors, which are for instance at least partially coupled, for instance via a bus. Processor 1101 executes a program code stored in program memory 1102 (for instance program code causing mobile device 1100 in connection with base station 1200 to perform one or more of the embodiments of a method according to the present disclosure or parts thereof, when executed on processor 1101, and interfaces with a main memory 1103. Program memory 1102 may also contain an operating system for processor 1101. Some or all of memories 1102 and 1103 may also be included into processor 1101.

One of or both of a main memory and a program memory of a processor (e.g. program memory 1102 and main memory 1103) could be fixedly connected to the processor (e.g. processor 1101) or at least partially removable from the processor, for instance in the form of a memory card or stick.

A program memory (e.g. program memory 602) may for instance be a non-volatile memory. It may for instance be a FLASH memory (or a part thereof), any of a ROM, PROM, EPROM, MRAM or a FeRAM (or a part thereof) or a hard disc (or a part thereof), to name but a few examples. For example, a program memory may for instance comprise a first memory section that is fixedly installed, and a second memory section that is removable from, for instance in the form of a removable SD memory card.

A main memory (e.g. main memory 1103) may for instance be a volatile memory. It may for instance be a DRAM memory, to give non-limiting example. It may for instance be used as a working memory for processor 1101 when executing an operating system, an application, a program, and/or the like.

Processor 1101 further controls a communication interface 1104 (e.g. radio interface) configured to receive and/or transmit data and/or information. For instance, communication interface 1104 may be configured to transmit and/or receive radio signals from a radio node, such as a base station. It is to be understood that any computer program code based processing required for receiving and/or evaluating radio signals may be stored in an own memory of communication interface 1104 and executed by an own processor of communication interface 1104 and/or it may be stored for example in memory 1103 and executed for example by processor 601.

Communication interface 1104 may in particular be configured to communicate according to a cellular communication system like a 2G/3G/4G/5G or future generation cellular communication system. Mobile device 1100 may use radio interface 1104 to communicate with a base station, e.g. base station 20, 703, 803, 903, 1003 depicted in FIGS. 2, 7-10.

For example, the communication interface 1104 may further comprise a BLE and/or Bluetooth radio interface including a BLE transmitter, receiver or transceiver. For example, radio interface 1104 may additionally or alternatively comprise a WLAN radio interface including at least a WLAN transmitter, receiver or transceiver.

The components 1102 to 1104 of mobile device 1100 may for instance be connected with processor 601 by means of one or more serial and/or parallel busses.

It is to be understood that mobile device 1100 may comprise various other components. For example, mobile device 1100 may optionally comprise a user interface (e.g. a touch-sensitive display, a keyboard, a touchpad, a display, etc.).

FIG. 12 is a block diagram of an exemplary embodiment of a network entity, such as base station or gNB 20. 703, 803, 903, 1003 (or a part thereof) of FIGS. 2, 7-10. For instance, base station 1200 may be configured for scheduling and/or transmitting signals to the UE, as described above.

Apparatus 1200 comprises a processor 1201. Processor 1201 may represent a single processor or two or more processors, which are for instance at least partially coupled, for instance via a bus. Processor 1201 executes a program code stored in program memory 1202 (for instance program code causing apparatus 1200 to perform alone or together with mobile device 1200 embodiments according to the present disclosure or parts thereof), and interfaces with a main memory 1203.

Program memory 1202 may also comprise an operating system for processor 1201. Some or all of memories 1202 and 1203 may also be included into processor 1201.

Moreover, processor 1201 controls a communication interface 1204 which is for example configured to communicate according to a cellular communication system like a 2G/3G/4G/5G cellular communication system. Communication interface 1204 of apparatus 1200 may be realized by radio heads 30 for instance and may be provided for communication between base station and UE.

The components 1202 to 1204 of apparatus 1200 may for instance be connected with processor 1201 by means of one or more serial and/or parallel busses.

Mobile device 1100 together with communication interface 1104 may in particular be configured for receiving signals from a network entity 1200 and transmitting signals to network entity 1200 according to the approach scheme describe herein.

It is to be understood that apparatuses 1100, 1200 may comprise various other components.

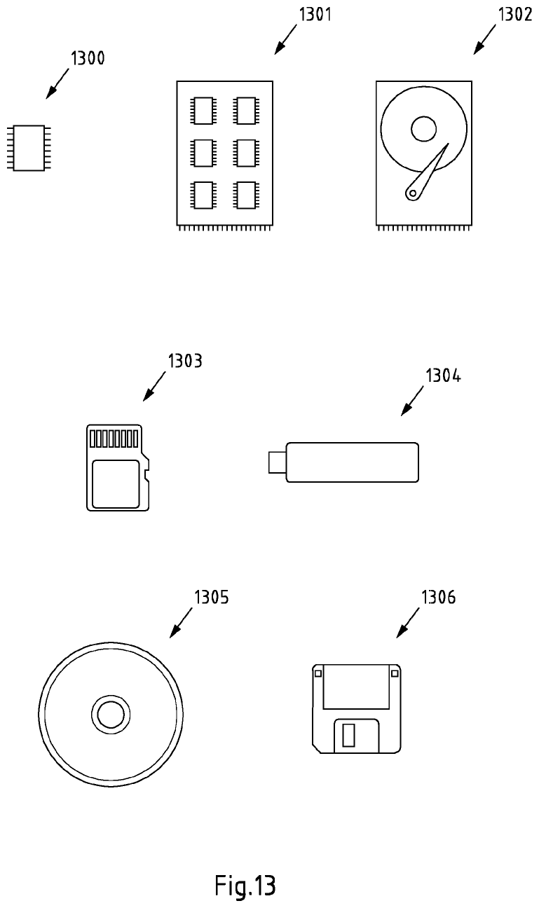

FIG. 13 is a schematic illustration of examples of tangible and non-transitory computer-readable storage media according to the present disclosure that may for instance be used to implement memory 1102 of FIG. 11 or memory 1202 of FIG. 12. To this end, FIG. 13 displays a flash memory 1300, which may for instance be soldered or bonded to a printed circuit board, a solid-state drive 1301 comprising a plurality of memory chips (e.g. Flash memory chips), a magnetic hard drive 1302, a Secure Digital (SD) card 1303, a Universal Serial Bus (USB) memory stick 1304, an optical storage medium 1305 (such as for instance a CD-ROM or DVD) and a magnetic storage medium 1306.

Any presented connection in the described embodiments is to be understood in a way that the involved components are operationally coupled. Thus, the connections can be direct or indirect with any number or combination of intervening elements, and there may be merely a functional relationship between the components.

Further, as used in this text, the term ‘circuitry’ refers to any of the following:
(a) hardware-only circuit implementations (such as implementations in only analog and/or digital circuitry)
(b) combinations of circuits and software (and/or firmware), such as: (i) to a combination of processor(s) or (ii) to sections of processor(s)/software (including digital signal processor(s)), software, and memory(ies) that work together to cause an apparatus, such as a mobile phone, to perform various functions) and
(c) to circuits, such as a microprocessor(s) or a section of a microprocessor(s), that re-quire software or firmware for operation, even if the software or firmware is not physically present.

This definition of ‘circuitry’ applies to all uses of this term in this text, including in any claims. As a further example, as used in this text, the term ‘circuitry’ also covers an implementation of merely a processor (or multiple processors) or section of a processor and its (or their) accompanying software and/or firmware. The term ‘circuitry’ also covers, for example, a baseband integrated circuit or applications processor integrated circuit for a mobile phone.

Any of the processors mentioned in this text, in particular but not limited to processors 1101 and 1201 of FIGS. 11 and 12, could be a processor of any suitable type. Any processor may comprise but is not limited to one or more microprocessors, one or more processor(s) with accompanying digital signal processor(s), one or more processor(s) without accompanying digital signal processor(s), one or more special-purpose computer chips, one or more field-programmable gate arrays (FPGAS), one or more controllers, one or more application-specific integrated circuits (ASICS), or one or more computer(s). The relevant structure/hardware has been programmed in such a way to carry out the described function.

Moreover, any of the actions or steps described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

Moreover, any of the actions described or illustrated herein may be implemented using executable instructions in a general-purpose or special-purpose processor and stored on a computer-readable storage medium (e.g., disk, memory, or the like) to be executed by such a processor. References to ‘computer-readable storage medium’ should be understood to encompass specialized circuits such as FPGAs, ASICs, signal processing devices, and other devices.

The wording “A, or B, or C, or a combination thereof” or “at least one of A, B and C” may be understood to be not exhaustive and to include at least the following: (i) A, or (ii) B, or (iii) C, or (iv) A and B, or (v) A and C, or (vi) B and C, or (vii) A and B and C.

It will be understood that the embodiments disclosed herein are only exemplary, and that any feature presented for a particular exemplary embodiment may be used with any aspect of the present disclosure on its own or in combination with any feature presented for the same or another particular exemplary embodiment and/or in combination with any other feature not mentioned. It will further be understood that any feature presented for an example embodiment in a particular category may also be used in a corresponding manner in an example embodiment of any other category.

1-20. (canceled)

21. A first apparatus comprising at least one processor, and at least one memory including computer program code, the at least one memory and the computer program code being configured to, with the at least one processor, cause the first apparatus at least to:
perform an uplink transmission to a base station in a serving cell, the uplink transmission being associated with the transmission of an uplink transport block;
establish a sidelink connection with a second apparatus;
transmit, to the second apparatus, a re-transmission request for an uplink re-transmission to the base station in the serving cell by the second apparatus on behalf of the first apparatus, the uplink re-transmission being associated with the transmission of the uplink transport block;
transmit, to the second apparatus, context information to be used by the second apparatus for the uplink re-transmission; and
transmit, to the second apparatus, uplink data to be used by the second apparatus for the uplink re-transmission.

22. The first apparatus of claim 21, wherein the first apparatus is further caused to determine a need for the uplink re-transmission based on at least one of:
a number of negative feedbacks or negative acknowledgements from the base station;
a worsening of one or more channel properties between the first apparatus and the base station, in particular of the channel state information;
a decrease of the signal to interference plus noise ratio of one or more radio signals received by the first apparatus from the base station; or a decision from a higher layer for the uplink re-transmission.

23. The first apparatus of claim 21, wherein at least one of the context information or the uplink data are transmitted pre-emptively before having determined a need for the uplink re-transmission.

24. The first apparatus of claim 21, wherein the re-transmission request comprises at least one of:
information indicative of an identifier of the serving cell;
information indicative of a remaining delay budget related to the uplink transport block;
information indicative of a size of the uplink data; or
information indicative of a quality of service for the transmission of the uplink transport block.

25. The first apparatus of claim 21, wherein the first apparatus is further caused to:
in response to the re-transmission request, receive, from the second apparatus, an indication as to whether the re-transmission request is accepted.

26. The first apparatus of claim 25, wherein the first apparatus is further caused to:
in case the second apparatus indicates that the re-transmission request is accepted, perform the transmission of at least one of the context information or the uplink data to the second apparatus; and/or
in case the second apparatus indicates that the re-transmission request is denied, transmit, to a third apparatus, a further re-transmission request for a further uplink re-transmission to the base station in the serving cell by the third apparatus on behalf of the first apparatus, the further uplink re-transmission being associated with the transmission of the uplink transport block.

27. The first apparatus of claim 21, wherein the first apparatus is further caused to:
transmit, to the second apparatus, a re-transmission command instructing the second apparatus to perform the uplink re-transmission.

28. The first apparatus of claim 27, wherein the re-transmission command comprises at least one of:
the context information; or
the uplink data.

29. The first apparatus of claim 21, wherein the uplink data transmitted to the second apparatus is:
the uplink transport block; or
an uplink codeword encoded in accordance with the context information.

30. The first apparatus of claim 21, wherein the context information comprises at least one of:
information indicative of a user equipment identifier assigned by the base station in the serving cell;
information indicative of an uplink grant for the uplink re-transmission;
information indicative of uplink resources to be used for the uplink re-transmission;
information indicative of a re-transmission process identifier to be used for the uplink re-transmission; or
information indicative of a redundancy version to be used for the uplink re-transmission.

31. The first apparatus of claim 21, wherein the sidelink connection is established with the second apparatus based on at least one of:
an application to which the uplink transport block pertains;
a certain required quality of service for the transmission of the uplink transport block; or
a decision from a higher layer, in particular a network layer.

32. A second apparatus comprising at least one processor, and at least one memory including computer program code, the at least one memory and the computer program code being configured to, with the at least one processor, cause the second apparatus at least to:
establish a sidelink connection with a first apparatus;
receive, from the first apparatus, a re-transmission request for an uplink re-transmission to a base station in a serving cell by the second apparatus on behalf of the first apparatus, the uplink re-transmission being associated with the transmission of an uplink transport block;
receive, from the first apparatus, context information to be used by the second apparatus for the uplink re-transmission;
receive, from the first apparatus, uplink data to be used by the second apparatus for the uplink re-transmission; and
perform the uplink re-transmission to the base station in the serving cell on behalf of the first apparatus.

33. The second apparatus of claim 32, wherein at least one of the context information or the uplink data are transmitted pre-emptively before having determined a need for the uplink re-transmission.

34. The second apparatus of claim 32, wherein the re-transmission request comprises at least one of:
information indicative of an identifier of the serving cell;
information indicative of a remaining delay budget related to the uplink transport block;
information indicative of a size of the uplink data; or
information indicative of a quality of service for the transmission of the uplink transport block.

35. The second apparatus of claim 32, wherein the second apparatus is further caused to:
in response to the re-transmission request, transmit, to the first apparatus, an indication as to whether the re-transmission request is accepted.

36. The second apparatus of claim 32, wherein the second apparatus is further caused to:
in case the uplink re-transmission by the second apparatus is unsuccessful, transmit, to a third apparatus, a further re-transmission request for a further uplink re-transmission to the base station in the serving cell by the third apparatus on behalf of the first apparatus, the further uplink re-transmission being associated with the transmission of the uplink transport block.

37. The second apparatus of claim 32, wherein the context information comprises at least one of:
information indicative of a user equipment identifier assigned by the base station in the serving cell;
information indicative of an uplink grant for the uplink re-transmission;
information indicative of uplink resources to be used for the uplink re-transmission;
information indicative of a re-transmission process identifier to be used for the uplink re-transmission; or
information indicative of a redundancy version to be used for the uplink re-transmission.

38. A base station comprising at least one processor, and at least one memory including computer program code, the at least one memory and the computer program code being configured to, with the at least one processor, cause the base station at least to:
receive, from a first apparatus, an indication for uplink re-transmission via another apparatus;
transmit, to the first apparatus, a first uplink grant providing a first uplink transmission opportunity for an uplink transmission to the base station in a serving cell, the uplink transmission being associated with the transmission of an uplink transport block; and
transmit, to the first apparatus, a second uplink grant providing a second uplink transmission opportunity for an uplink re-transmission to the base station in the serving cell, the uplink re-transmission being associated with the transmission of the uplink transport block;
adjust a time separation between the transmission of the second uplink grant and the second uplink transmission opportunity based on the indication; and
receive, from a second apparatus, the uplink re-transmission on behalf of the first apparatus.

39. The base station of claim 38, wherein the base station is further caused to:
transmit, to the first apparatus, information indicative of a sidelink resource allocation for sidelink communication between the first apparatus and the second apparatus, the second uplink transmission opportunity being time-coordinated with the sidelink resource allocation.

40. The base station of claim 38, wherein the base station is further caused to:
receive, from the first apparatus, information indicative of a delay required between the transmission of the second uplink grant and the second uplink transmission opportunity for the uplink re-transmission.
